(19) United States
(12) Patent Application Publication
(10) Pub. No.: US 2005/0078096 A1
(43) Pub. Date: Apr. 14, 2005

(54) Touch pen module

(76) Inventor: Kuang-Cheng Fan, Taipei City (TW)

Correspondence Address: LOWE HAUPTMAN GILMAN & BERNER, LLP, Suite 310, 1700 Diagonal Road, Alexandria, VA, 22314, US

(21) Appl. No.: 10/680,130

(22) Filed: Oct. 8, 2003

(51) Int. Cl. G09G 5/00

(52) U.S. Cl. 345/179

(57) ABSTRACT

A touch pen module is disclosed. The touch pen module includes a pen tip and a pen body. The pen tip has at least one bulge or at least one notch and the pen body has at least one notch corresponding to the bulge or at least one bulge corresponding to the notch. The pen tip and the pen body are integrated via the bulge and the notch or vice versa.

### BACKGROUND OF THE INVENTION

1. Field of the Invention

The present invention relates to a touch pen module, and more particularly to a touch pen module which uses at least one bulge or at least one notch to assemble a pen tip and a pen body.

2. Description of the Related Art

Conventional touch pen used to touch the display surface of an electronic device to select and execute functions thereof has a separate pen tip made of a specific material. FIG. 1 shows a conventional touch pen 100 including a pen tip 102 and a pen body 104. The material of the pen tip of a conventional touch pen comprises polyoxymethylene (POM) which is special and expensive, and must be manufactured independently. However, the pen body of a conventional touch pen is usual and can be manufactured by a common process such as injection molding. To integrate the pen tip and the pen body to complete a touch pen, the pen tip and the pen body must be assembled and glued artificially by workers. The pen tip and the pen body can also be assembled by placing the pen tip in the mold of the pen body during the injection molding process.

The integration processes of the pen tip and the pen body set forth have several drawbacks. For example, artificially assembling and gluing the pen tip and the pen body by workers is hard to standardize. The quantity of the glue used on every pen tip and every pen body is hard to unify thereby reduce the reliability and the yield ratio of the touch pen. Placing the pen tip in the mold of the pen body during the injection molding process would increase the complexity, cycle time and cost of production.

Thus it is necessary to provide a new touch pen module to resolve the drawbacks set forth. It is towards those goals that the present invention is specifically directed.

### SUMMARY OF THE INVENTION

It is therefore an object of the invention to provide a touch pen module with a high reliability.

It is another object of this invention to provide a touch pen module which is easy to be produced.

It is a further object of this invention to provide a low production cost touch pen module.

To achieve these objects, and in accordance with the purpose of the invention, the invention uses a touch pen module, the touch pen module comprises a pen body having a socket comprising at least one notch, and a pen tip having an elongation comprising at least one bulge, wherein the pen body and the pen tip are assembled by insertions of the elongation into the socket and the bulge into the notch.

In another embodiment of this invention, the invention uses A touch pen module, the touch pen module comprises a pen tip having a socket comprising at least one bulge, and a pen body having an elongation comprising at least one notch, wherein the pen body and the pen tip are assembled by insertions of the elongation into the socket and the bulge into the notch.

In another embodiment of this invention, the invention uses A touch pen module, the touch pen module comprises a pen body having a socket comprising at least one bulge, and a pen tip having an elongation comprising at least one notch, wherein the pen body and the pen tip are assembled by insertions of the elongation into the socket and the bulge into the notch.

In another embodiment of this invention, the invention uses A touch pen module, the touch pen module comprising: A touch pen module, the touch pen module comprises a pen body having a socket comprising at least two hole, and a pen tip having at least two elongations each comprising at least one bulge, wherein the pen body and the pen tip are assembled by insertions of the elongations into the socket and the bulge into the holes.

It is to be understood that both the foregoing general description and the following detailed description are exemplary and explanatory only and are not restrictive of the invention, as claimed.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIG. 1 shows a conventional touch pen including a pen tip and a pen body;

FIG. 2A shows an embodiment of the touch pen module of the invention;

FIG. 2B shows an embodiment of touch pen as a result of assembling the pen tip and the pen body of the invention;

FIG. 3A shows a second embodiment of the touch pen module of the invention;

FIG. 3B shows a second embodiment of touch pen as a result of assembling the pen tip and the pen body of the invention;

FIG. 4A shows a third embodiment of the touch pen module of the invention;

FIG. 4B shows a third embodiment of touch pen as a result of assembling the pen tip and the pen body of the invention;

FIG. 5A shows a fourth embodiment of the touch pen module of the invention;

FIG. 5B shows a fourth embodiment of touch pen as a result of assembling the pen tip and the pen body of the invention;

FIG. 6A shows a fifth embodiment of the touch pen module of the invention;

FIG. 6B shows a top view of touch pen as a result of assembling the pen tip and the pen body of the invention; and

FIG. 6C shows a front view of the touch pen module of the invention.

### DESCRIPTION OF THE PREFERRED EMBODIMENT

It is to be understood and appreciated that the process steps and structures described below do not cover a complete process flow and structure. The present invention can be practiced in conjunction with various fabrication techniques that are used in the art, and only so much of the commonly practiced process steps are included herein as are necessary to provide an understanding of the present invention.

The present invention will be described in detail with reference to the accompanying drawings. It should be noted that the drawings are in greatly simplified form and they are not drawn to scale. Moreover, dimensions have been exaggerated in order to provide a clear illustration and understanding of the present invention.

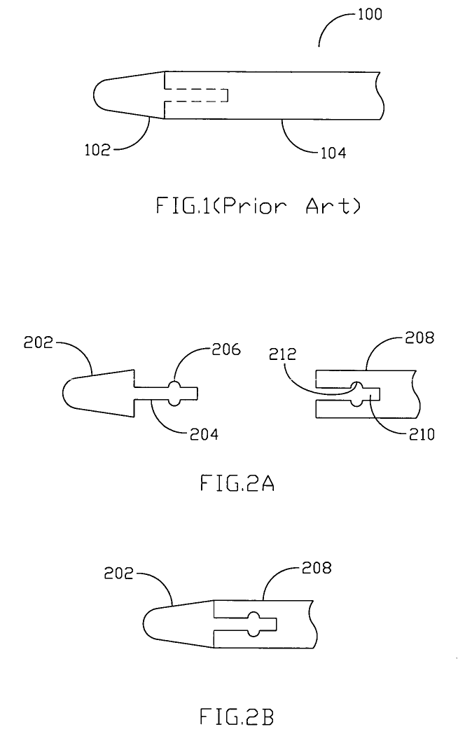

In one embodiment of the invention, the touch pen module of the invention uses at least one bulge or at least one notch to assemble a pen tip and a pen body. Referring to FIG. 2A, a pen tip 202 having an elongation 204 and two bulges 206 and a pen body 208 including a socket 210 for accommodating the elongation 204 and two notches 212 for accommodating the bulges 206 are shown. The bulges 206 are located on the elongation 204 and the notches 212 are on the inner surface of the socket 210. The number of the bulge and the notch shown in FIG. 2A is just an example, not a limitation. FIG. 2B shows a touch pen as a result of assembling the pen tip 202 and the pen body 208. The elongation 204 and the bulges 206 of the pen tip 202 are inserted into the socket 210 and the notches 212 respectively. The pen tip 202 and the pen body 208 are integrated and fixed by the wedging or joining of the bulges 206 and the notches 212. Although the shapes of the bulges 206 and the notches 212 shown in FIG. 2A are hemisphere, the shapes of the bulges 206 and the notches 212 can also be other geometrical forms. Because the pen tip 202 is assembled with the pen body 208 via the bulges 206 and the notches 212, the pen tip 202 can be replaced easily if necessary. The pen tip 202 can be colored or be fluorescent. The pen body 208 can be manufactured by injection molding and the pen tip 202 can be made of polyoxymethylene (POM).

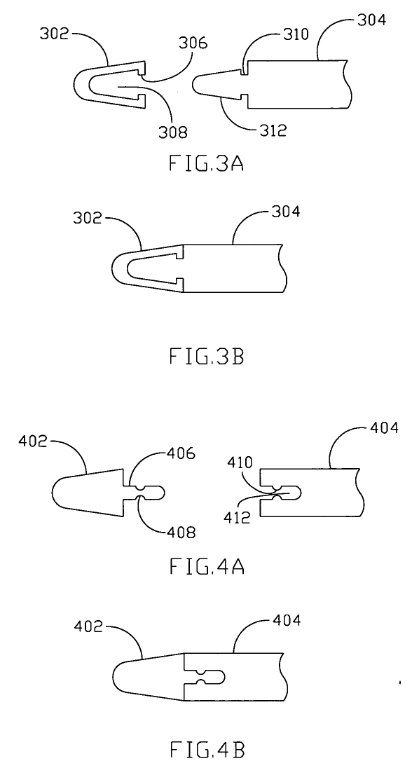

In a second embodiment of the invention, the touch pen module of the invention also uses bulges, notches and a socket to assemble a pen tip and a pen body, while the notches are located on the pen body and the bulges and the socket are on the pen tip. Referring to FIG. 3A, a pen tip 302 having two bulges 306 and a socket 308, and a pen body 304 including two notches 310 and an elongation 312 are shown, wherein the socket 308 accommodates the elongation 312 and the notches 310 accommodate the bulges 306. The number of the bulge and the notch shown in FIG. 3A is just an example, not a limitation. The bulges 306 can be located on the inner surface of the socket 308 or the edge of the pen tip 302. The notches 310 can be located the elongation 312 other than the root thereof. The bulges 306 can also be replaced with a cyclic bulge and the notches 310 can be replaced with a cyclic fillister. FIG. 3B shows a touch pen as a result of assembling the pen tip 302 and the pen body 304. The bulges 306 of the pen tip 302 are inserted into notches 310 of the pen body 304 when the elongation 312 of the pen body 304 are inserted into the socket 308 of the pen tip 302. The pen tip 302 and the pen body 304 are integrated and fixed by the wedging or joining of the bulges 306 and the notches 310. Although the shapes of the bulges 306 and the notches 310 shown in FIG. 3A are cube, the shapes of the bulges 306 and the notches 310 can also be other geometrical forms. Furthermore, although the shapes of the elongation 312 and the socket 308 are cone, the shapes of the elongation 312 and the socket 308 can also be other geometrical forms. Because the pen tip 302 is assembled with the pen body 304 via the bulges 306 and the notches 310, the pen tip 302 can be replaced easily if necessary. The pen tip 302 can be colored or be fluorescent. The pen body 304 can be manufactured by injection molding and the pen tip 302 can be made of polyoxymethylene (POM).

In a third embodiment of the invention, the touch pen module of the invention utilizes bulges, notches and a socket to assemble a pen tip and a pen body, while the notches are located on an elongation of the pen tip and the bulges and the socket are on the pen body. Referring to FIG. 4A, a pen tip 402 having an elongation 406 and two notches 408 and a pen body 404 including a socket 412 for accommodating the elongation 406 and two bulges 410 for inserting the notches 408 are shown. The notches 408 are located on the elongation 406 and the bulges 410 are on the inner surface of the socket 412. The number of the bulge and the notch shown in FIG. 4A is just an example, not a limitation. FIG. 4B shows a touch pen as a result of assembling the pen tip 402 and the pen body 404. The bulges 410 are inserted into the notches 408 when the elongation 406 are inserted into the socket 412. The pen tip 402 and the pen body 404 are integrated and fixed by the wedging or joining of the bulges 410 and the notches 408. Although the shapes of the bulges 410 and the notches 408 shown in FIG. 4A are hemisphere, the shapes of the bulges 410 and the notches 408 can also be other geometrical forms. Because the pen tip 402 is assembled with the pen body 404 via the bulges 410 and the notches 408, the pen tip 402 can be replaced easily if necessary. The pen tip 402 can be colored or be fluorescent. The pen tip 402 can be made of polyoxymethylene (POM) and the pen body 404 can be manufactured by injection molding.

In a fourth embodiment of the invention, the touch pen module of the invention uses at least one bulge or at least one notch to assemble a pen tip and a pen body. Referring to FIG. 5A, a pen tip 502 having an elongation 508 and two hook bulges 506 and a pen body 504 including a socket 510 for accommodating the elongation 508 and two notches 512 for accommodating the hook bulges 506 are shown. The hook bulges 506 are located on the elongation 508 and the notches 512 are on the inner surface of the socket 510. The number of the bulge and the notch shown in FIG. 5A is just an example, not a limitation. FIG. 5B shows a touch pen as a result of assembling the pen tip 502 and the pen body 504. The elongation 508 and the hook bulges 506 of the pen tip 502 are inserted into the socket 510 and the notches 512 respectively. The pen tip 502 and the pen body 504 are integrated and fixed by the wedging or joining of the hook bulges 506 and the notches 512. Although the shapes of the hook bulges 506 and the notches 512 shown in FIG. 5A are triangular cube, the shapes of the hook bulges 506 and the notches 512 can also be other geometrical forms. Because the pen tip 502 is assembled with the pen body 504 via the hook bulges 506 and the notches 512, the pen tip 502 can be replaced easily if necessary. The pen tip 502 can be colored or be fluorescent. The pen tip 502 can be made of POM and the pen body 504 can be manufactured by injection molding.

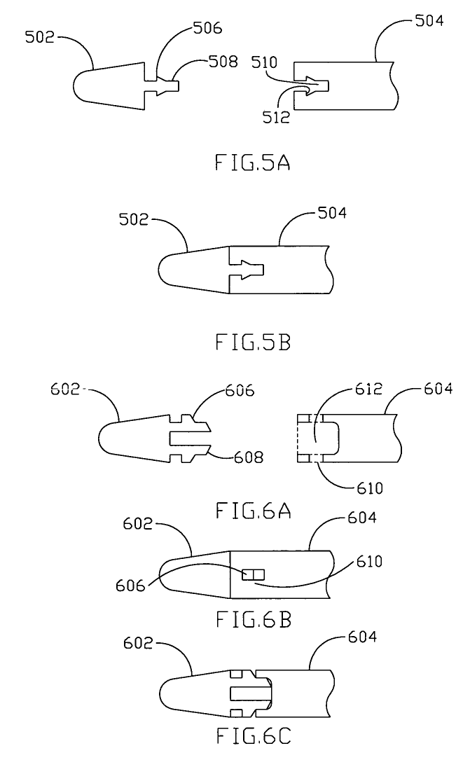

In a fifth embodiment of the invention, the touch pen module of the invention uses elongations and bulges of a pen tip and a socket and holes to assemble a pen tip and a pen body. Referring to FIG. 6A, a pen tip 602 having two elongations 608 and two bulges 606, and a pen body 604 including a socket 612 for accommodating the elongations 608 and two holes 610 for accommodating the bulges 606 are shown. The bulges 606 are located on the elongations 608 and the holes 610 connect the socket 612 to the outside of the pen body 604. The number of the bulge and the hole shown in FIG. 6A is just an example, not a limitation. FIG. 6B shows a top view of a touch pen as a result of assembling the pen tip 602 and the pen body 604. The elongations 608 and the bulges 606 of the pen tip 602 are inserted into the socket 612 and the holes 610 respectively. The pen tip 602 and the pen body 604 are integrated and fixed by the wedging or joining of the bulges 606 and the holes 610. The bulges 606 insert into and through the holes 610 and become a part of the outer surface of the pen body 604. However, the bulges 606 can also just insert into the holes 610 but not completely through the holes 610, and the holes 610 are caves. FIG. 6C shows a front view of the touch pen as a result of assembling the pen tip 602 and the pen body 604. The shapes of the bulges 606 and the holes 610 shown in FIG. 6A are only examples, not limitations, the shapes of the bulges 606 and the holes 610 can also be other geometrical forms. Because the pen tip 602 is assembled with the pen body 604 via the bulges 606 and the holes 610, the pen tip 602 can be replaced easily if necessary. The pen tip 602 can be colored or be fluorescent. The pen tip 602 can be made of POM and the pen body 604 can be manufactured by injection molding.

The touch pen module of the invention which utilizes bulges, an elongation, notches and a socket to assemble a pen tip and a pen body has advantages of high reliability, production convenience and low cost which the conventional touch pen lacks. The touch pen module of the invention avoids the standardization problem, poor reliability and low yield ratio of the conventional touch pen resulting from artificially assembling and gluing the pen tip and the pen body by workers. The touch pen module of the invention also avoids the increases of the complexity, cycle time and cost of production of the conventional touch pen induced by placing the pen tip in the mold of the pen body during the injection molding process.

Other embodiments of the invention will appear to those skilled in the art from consideration of the specification and practice of the invention disclosed herein. It is intended that the specification and examples to be considered as exemplary only, with a true scope and spirit of the invention being indicated by the following claims.

1. A touch pen module, said touch pen module comprising:
a pen body having a socket comprising at least one notch; and
a pen tip having an elongation comprising at least one bulge, wherein said pen body and said pen tip are assembled by insertions of said elongation into said socket and said bulge into said notch.

2. The touch pen module according to claim 1, wherein said pen tip is made of polyoxymethylene (POM).

3. The touch pen module according to claim 1, wherein said pen body is manufactured by injection molding.

4. The touch pen module according to claim 1, wherein said bulge comprises a hemisphere bulge and said notch has a hemisphere shape.

5. The touch pen module according to claim 1, wherein said bulge comprises a hook bulge and said notch has a hook shape.

6. A touch pen module, said touch pen module comprising:
a pen tip having a socket comprising at least one bulge; and
a pen body having an elongation comprising at least one notch, wherein said pen body and said pen tip are assembled by insertions of said elongation into said socket and said bulge into said notch.

7. The touch pen module according to claim 6, wherein said pen tip is made of polyoxymethylene (POM)

8. The touch pen module according to claim 6, wherein said pen body is manufactured by injection molding.

9. The touch pen module according to claim 6, wherein said bulge is located at the edge of said pen tip.

10. The touch pen module according to claim 6, wherein said elongation comprises a cone elongation and said socket has a cone shape.

11. A touch pen module, said touch pen module comprising:
a pen body having a socket comprising at least one bulge; and
a pen tip having an elongation comprising at least one notch, wherein said pen body and said pen tip are assembled by insertions of said elongation into said socket and said bulge into said notch.

12. The touch pen module according to claim 1 1, wherein said pen tip is made of polyoxymethylene (POM).

13. The touch pen module according to claim 11, wherein said pen body is manufactured by injection molding.

14. The touch pen module according to claim 11, wherein said bulge comprises a hemisphere bulge and said notch has a hemisphere shape.

15. The touch pen module according to claim 11, wherein said bulge comprises a hook bulge and said notch has a hook shape.

16. A touch pen module, said touch pen module comprising:
a pen body having a socket comprising at least two hole; and
a pen tip having at least two elongations each comprising at least one bulge, wherein said pen body and said pen tip are assembled by insertions of said elongations into said socket and said bulge into said holes.

17. The touch pen module according to claim 16, wherein said pen tip is made of polyoxymethylene (POM).

18. The touch pen module according to claim 16, wherein said pen body is manufactured by injection molding.

19. The touch pen module according to claim 16, wherein said hole connect said socket to the outside of said pen body.

20. The touch pen module according to claim 16, wherein said bulge inserts into and through said hole and become a part of the outer surface of said pen body.
